(19) United States
(12) Patent Application Publication
(10) Pub. No.: US 2022/0121906 A1
(43) Pub. Date: Apr. 21, 2022

(54) TASK-AWARE NEURAL NETWORK ARCHITECTURE SEARCH

(71) Applicant: GOOGLE LLC, Mountain View, CA (US)

(72) Inventors: EFFROSYNI KOKIOPOULOU, Zurich (CH); ANJA HAUTH, Zurich (CH); LUCIANO SBAIZ, Zurich (CH); ANDREA GESMUNDO, Zurich (CH); GABOR BARTOK, Zurich (CH); JESSE BERENT, Zurich (CH)

(21) Appl. No.: 17/427,173

(22) PCT Filed: Jan. 30, 2020
(86) PCT No.: PCT/US2020/015856

§ 371 Date: Jul. 30, 2021

(30) Foreign Application Priority Data
Jan. 30, 2019 (GR) 20190100048

(51) Int. Cl. G06N 3/04; G06V 10/82; G06N 3/08

(52) U.S. Cl. CPC G06N 3/0454; G06N 3/08; G06V 10/82

(57) ABSTRACT

A method of determining a final architecture for a task neural network for performing a target machine learning task is described. The target machine learning task is associated with a target training dataset. The method includes: generating a target meta-features tensor for the target training dataset, wherein the target meta-features tensor represents features of the target training dataset; repeatedly performing the following operations: generating, from a search space defining multiple architectures, a candidate architecture for the task neural network for performing the target machine learning task, and processing an input comprising the target meta-features tensor and data specifying the candidate architecture using an evaluator neural network to generate a candidate performance score that estimates a performance of the candidate architecture on the target machine learning task; and identifying, as the final architecture, a candidate architecture that has a maximum candidate performance score among the candidate architectures.

### CROSS-REFERENCE TO RELATED APPLICATION

This application claims priority to Greek Application Serial No. 20190100048, filed on Jan. 30, 2019. The disclosure of the prior application is considered part of and is incorporated by reference in the disclosure of this application.

### BACKGROUND

This specification relates to determining architectures for neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes a system implemented as computer programs on one or more computers in one or more locations that determines a final architecture for a task neural network that is configured to perform a target machine learning task. Existing approaches for identifying effective architectures for new machine learning tasks tend to be computationally inefficient and also not to be scalable in terms of computing resources.

The subject matter described in this specification can be implemented in particular embodiments so as to address the aforementioned issues with conventional approaches and/or to realize one or more of the following advantages. The techniques described in this specification can quickly identify, given a new machine learning task, an effective architecture for performing the new task before any candidate architecture is trained on the new task, thereby reducing computational costs that conventional methods would require to train candidate architectures. In addition, the described techniques may exhibit high scalability in terms of computing resources, as well as the ability to scale and learn collectively across task data sets.

In particular, the described techniques identify an effective architecture for performing the new task by selecting, among candidate architectures, an architecture that has a maximum performance estimated by an evaluator neural network. The described techniques further use a continuous parametrization of model architecture which allows for efficient gradient-based optimization of the estimated performance. In particular, the best candidate architecture can be efficiently identified, i.e. identified in a manner that makes efficient use of computational resources, by maximizing the estimated performance with respect to the continuous architecture parameters with simple gradient ascent. In addition, by training the evaluator neural network to estimate the performance of input architectures on a task using meta-features and the previous model training experiments performed on related tasks, the techniques can leverage transfer learning across different training datasets associated with different tasks, thus significantly reducing the computational costs of neural network search that conventional neural network search systems would require.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural architecture search system for determining a final architecture for a task neural network to perform a target machine learning task.

FIG. 2 is a flow diagram of an example process for determining a final architecture for a task neural network to perform a target machine learning task.

FIG. 3 is a flow diagram of an example process for training an evaluator neural network.

FIG. 4 illustrates a simplified example architecture of the task neural network.

Like reference numbers and designations in the various drawings indicate like elements.

### DETAILED DESCRIPTION

This specification describes a system implemented as computer programs on one or more computers in one or more locations that determines a final architecture for a task neural network that is configured to perform a target machine learning task. The target machine learning task is associated with a target training dataset.

In general, the task neural network is configured to receive a network input and to process the network input to generate a network output for the input.

In some cases, the task neural network is a convolutional neural network that is configured to receive an input image and to process the input image to generate a network output for the input image, i.e., to perform some kind of image processing task.

For example, the image processing task may be image classification and the output generated by the neural network for a given image may be scores for each of a set of object categories, with each score representing an estimated likelihood that the image contains an image of an object belonging to the category.

As another example, the image processing task may be image embedding generation and the output generated by the neural network can be a numeric embedding of the input image.

As yet another example, the image processing task may be object detection and the output generated by the neural network can identify locations in the input image at which particular types of objects are depicted.

In some other cases, the target machine learning task can be video classification and the target neural network is configured to receive as input a video or a portion of a video and to generate an output that determines what topic or topics that the input video or video portion relates to.

In some other cases, the target machine learning task can be speech recognition and the target neural network is configured to receive as input audio data and to generate an output that determines, for a given spoken utterance, the term or terms that the utterance represents.

In some other cases, the target machine learning task can be text classification and the target neural network is configured to receive an input text segment and to generate an output that determines what topic or topics an input text segment relates to.

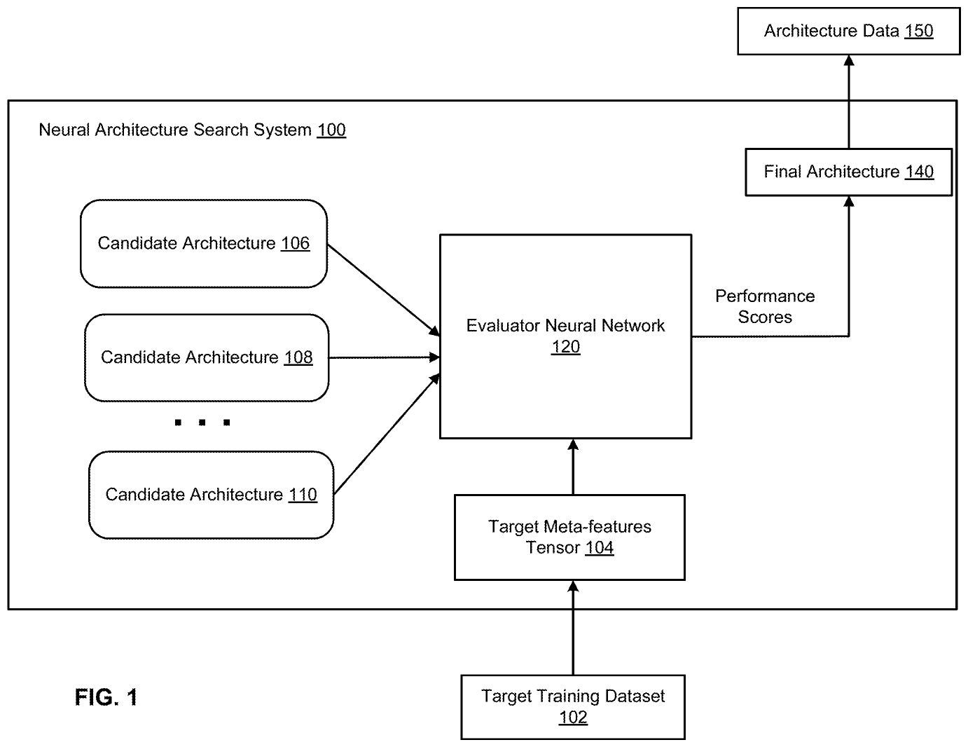

FIG. 1 shows an example neural architecture search system 100 configured to determine a final architecture for a task neural network that is configured to perform a target machine learning task. The neural architecture search system 100 is an example of a system implemented as computer programs on one or more computers in one or more locations, in which the systems, components, and techniques described below can be implemented.

The system 100 receives a target training dataset 102 that is associated with the target machine learning task, i.e, that is a dataset on which a neural network should be trained in order to be able to perform the target task. The system 100 can receive the target training dataset 102 in any of a variety of ways. For example, the system 100 can receive the target training dataset 102 as an upload from a remote user of the system over a data communication network, e.g., using an application programming interface (API) made available by the system 100. As another example, the system 100 can receive an input from a user specifying which data that is already maintained by the system 100 should be used as data identifying the target training dataset 102.

The system 100 then generates a target meta-features tensor 104 for the target training dataset 102. The target training dataset 102 includes a plurality of samples and a respective label for each of the samples. For example, if the target machine learning task is an image classification or recognition task, a sample in the dataset 102 can be an image and its respective label can be a ground-truth output that includes scores for each of a set of object classes, with each score representing the likelihood that the image contains an image of an object belonging to the object class. The target meta-features tensor 104 represents features (e.g., characteristics and statistics) of the target training dataset 102. More specifically, the target meta-features tensor may include one or more of the following meta-features: total number of samples in the target training dataset 102, number of object classes and their distribution, label entropy, total number of features and statistics about the features (min, max, mean or median), mutual information between the features and the labels in the dataset 102, or task id of the target machine learning task. The label entropy can be Shannon entropy computed over the distribution of labels in target training dataset 102. The mutual information between the features and labels captures how informative are the features for predicting labels.

In some implementations, instead of computing above meta-features from the target training dataset 102, the system 100 may process, using a feature generator neural network, the target training dataset 102 to generate the target meta-features tensor. The feature generator neural network has been trained to process a given training dataset to generate a corresponding meta-features tensor for the given training dataset. In these implementations, the target training dataset 102 (or a fraction of the dataset 102) is given as input to the feature generator neural network, and a task embedding is learned directly from samples in the target training dataset 102. The task embedding plays the roles of the meta-features in the target meta-features tensor 104. The feature generator neural network can be part of an evaluator neural network 120 (that is used to evaluate performance of a candidate architecture of the task neural network) and can be jointly trained with the evaluator neural network 120 using a common objective function.

The task neural network generally includes a plurality of parametrized layers with each parametrized layer being a weighted combination of one or more baseline layers based on parametrization weights.

The parameterization weights for each parametrized layer are in a set of continuous architecture parameters.

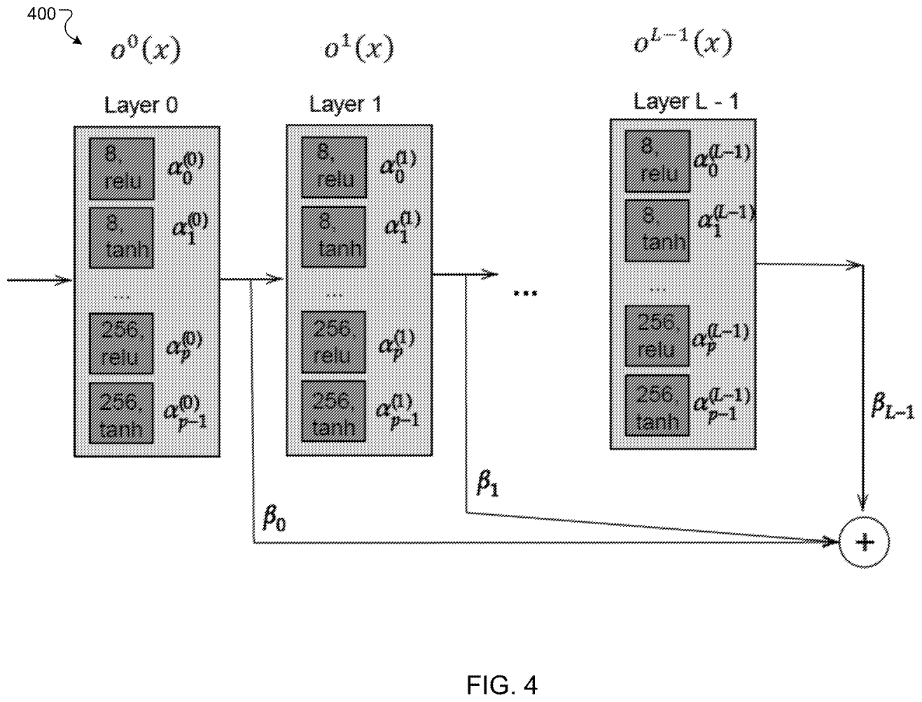

For example, as illustrated by FIG. 4, each layer o^{j}(x) of the task neural network includes p baseline layers oᵢ^{j}(x) corresponding to different sizes and different activation functions, where i denotes a baseline layer index and j denotes a parametrized layer index, and where p could be the same for all parametrized layers or different for different parametrized layers of the task neural network. Each baseline layer of oᵢ^{j}(x) is associated with a parameterization weight αᵢ^{j}, and each parametrized layer can be defined as follows:

$${o}^{j} ( x ) = {\sum }_{i = 1}^{p} \frac{exp ( {α}_{i}^{j} )}{{\sum }_{k = 1}^{p} exp ( {α}_{k}^{j} )} {o}_{i}^{j} ( x )$$

where αᵢ^{j} represents the parametrization weight that multiplies the output of the i-th baseline layer in the j-th parametrized layer of the task neural network.

The values of the parameterization weights αᵢ allow the final parametrized layer o^{j}(x) to change from one size to another and/or from one activation function to another. The system 100 may use zero padding whenever needed to resolve the dimension mismatch among base layers of different sizes.

The parametrized layers in the task neural network are further combined according to activation weights β. The activation weight βⱼ for each parametrized layer j belongs to the set of continuous architecture parameters and is a weight by which the output of the parametrized layer is multiplied before being provided to another layer of the task neural network. Thus, the activation weights can control the presence or absence of each parametrized layer independently from the other layers.

In some implementations, the first parametrized layer of the neural network is a parametrized embedding layer that is a weighted combination of one or more baseline embedding layers based on embedding weights γ. The embedding weights belong to the set of continuous architecture parameters. The use of the parametrized embedding layer can speed up training time for candidate architectures of the task neural network and improve their quality especially when the training set is small.

The set of continuous architecture parameters (including all possible values of the parametrization weights, activation weights, and embedding weights) defines a continuous search space for searching for a final architecture for the task neural network. Searching for the final architecture includes learning continuous parameters, for example, learning u:={{α}}, {β}, {γ}}, where u represents an encoding of the final architecture.

To determine the final architecture for the task neural network, the system 100 generates, from the continuous search space, a candidate architecture (e.g., candidate architecture 106) for the task neural network for performing the target machine learning task. The search space is represented by the above set of continuous architecture parameters.

The system 100 repeatedly generates candidate architectures (e.g., candidate architectures 106, 108, and 110) from the search space and evaluates performance of each of the generated candidate architectures.

In particular, to generate a candidate architecture (e.g., candidate architecture 106) from the search space, the system 100 generates new values for the set of architecture parameters from current values of the set of architecture parameters. The system 100 can generate the new values by performing gradient ascent search or random search (or another approximate optimization method) from the current values of the set of architecture parameters.

For example, in some implementations, the system 100 performs a gradient ascent search from the current values of the set of architecture parameters in the search space by determining a gradient of an output of an evaluator neural network 120 with respect to the current values of the set of architecture parameters while holding parameters of the evaluator neural network fixed. The system 100 then returns a result of the gradient ascent search as the new values of the set of architecture parameters.

In some other implementations, the system 100 performs a random search from the current values of the set of architecture parameters in the search space, and returns a result of the random search as the new values of the set of architecture parameters.

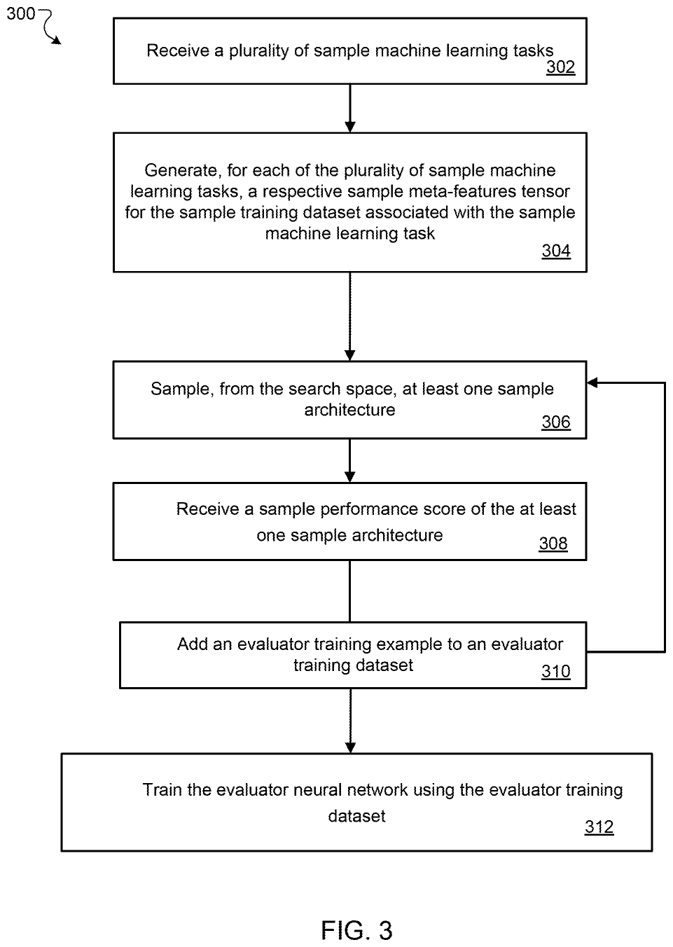

To evaluate performance of the candidate architecture 106, the system 100 uses an evaluator neural network 120. The evaluator neural network 120 has been trained to process an input including (i) a meta-features tensor of a given training dataset associated with a given machine learning task, and (ii) data specifying a given architecture to generate a performance score that estimates a performance of the given architecture on the given machine learning task. The evaluator neural network 120 can be trained using machine learning techniques such as stochastic gradient descent with momentum, as described in Ning Qian, “On the momentum term in gradient descent learning algorithms,” Neural Netw., 12(1):145-151, January 1999. The process for training the evaluator neural network 120 is described in more detail below with reference to FIG. 3.

The evaluator neural network 120 may include a plurality of fully-connected neural network layers. For example, the evaluator neural network 120 may include two fully connected layers of size 50 followed by two fully connected layers of sizes 50 and 10.

As described above, the evaluator neural network 120 may include the feature generator neural network and can be trained jointly with the feature generator neural network using a common objective function. For example, the common objective function minimizes the difference between (i) sample performance scores received for the plurality of sample machine learning tasks, and (ii) performance scores predicted by the evaluator neural network given the plurality of sample machine learning tasks.

The system 100 processes an input including the target meta-features tensor 104 and data specifying the candidate architecture 106 using the evaluator neural network 120 to generate a respective candidate performance score that estimates a performance of the candidate architecture 106 on the target machine learning task.

After generating the candidate architectures and determining their respective candidate performance scores, the system 100 identifies, as the final architecture 140, a candidate architecture that has a maximum candidate performance score among the generated candidate architectures.

The system 100 can then output architecture data 150 that specifies the final architecture 140 of the neural network, i.e., data specifying the layers that are part of the final architecture, the connectivity between the layers, and the operations performed by the layers. For example, the system 100 can output the architecture data 150 to the user who submitted the target training dataset.

In some implementations, instead of or in addition to outputting the architecture data 150, the system 100 trains an instance of the neural network having the final architecture and then uses the trained neural network to process requests received by users, e.g., through the API provided by the system 100. That is, the system 100 can receive inputs to be processed, use the trained neural network having the final architecture to process the inputs, and provide the outputs generated by the trained neural network or data derived from the generated outputs in response to the received inputs.

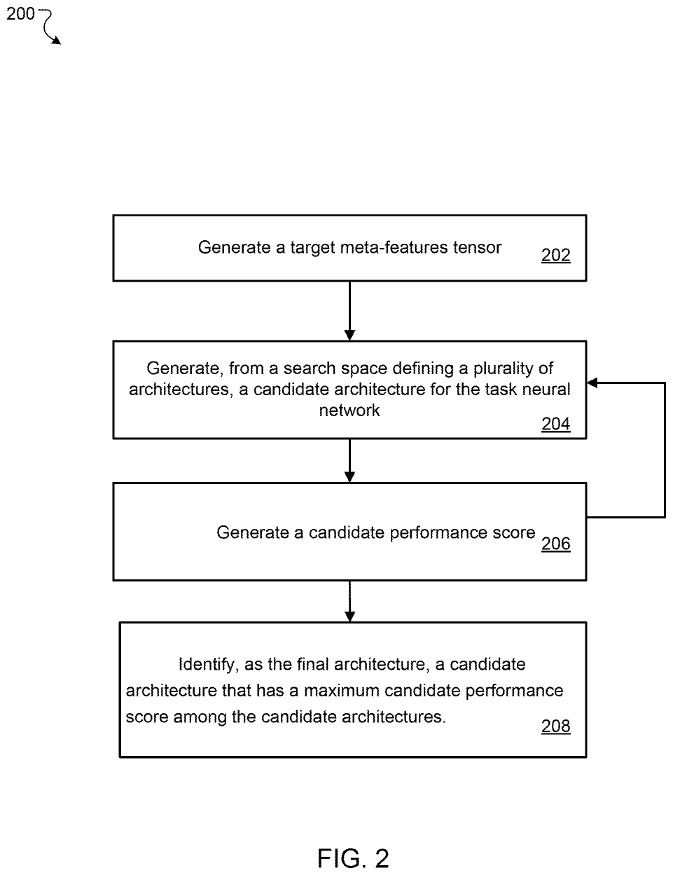

FIG. 2 is a flow diagram of an example process 200 for determining a final architecture for a task neural network to perform a target machine learning task. For convenience, the process 200 will be described as being performed by a system of one or more computers located in one or more locations. For example, a neural architecture search system, e.g., the neural architecture search system 100 of FIG. 1, appropriately programmed, can perform the process 200.

The system generates a target meta-features tensor for the target training dataset (step 202). The target meta-features tensor represents features of the target training dataset. More specifically, the target meta-features tensor may include one or more of the following: total number of samples in the target training dataset, number of classes and their distribution, label entropy, total number of features and statistics about them (min, max, median), mutual information of the features with the label, or task id of the target machine learning task.

The system repeatedly performs steps 204-206 as follows.

The system generates, from a search space defining a plurality of architectures, a candidate architecture for the task neural network for performing the target machine learning task (step 204). The search space is represented by a set of continuous architecture parameters.

To generate the candidate architecture from the search space, the system generates new values for the set of architecture parameters from current values of the set of architecture parameters. The system can generate the new values by performing gradient ascent search or random search (or another approximate optimization method) from the current values of the set of architecture parameters.

For example, in some implementations, the system performs a gradient ascent search from the current values of the set of architecture parameters in the search space by determining a gradient of an output of an evaluator neural network with respect to the current values of the set of architecture parameters while holding parameters of the evaluator neural network fixed. The system can then multiply the gradient by a learning rate constant and add the resulting product to or subtract the resulting product from the current values to generate the new values. The system then returns a result of the gradient ascent search as the new values of the set of architecture parameters.

In some other implementations, the system performs a random search from the current values of the set of architecture parameters in the search space, and returns a result of the random search as the new values of the set of architecture parameters.

The system processes an input including the target meta-features tensor and data specifying the candidate architecture using an evaluator neural network to generate a candidate performance score that estimates a performance of the candidate architecture on the target machine learning task (step 206).

The system repeats steps 204-206 to generate a plurality of candidate architectures from the search space and to use the evaluator neural network to generate a corresponding candidate performance score for each of the plurality of candidate architectures.

The system then identifies, as the final architecture, a candidate architecture that has a maximum candidate performance score among the candidate architectures (step 208).

FIG. 3 is a flow diagram of an example process for training an evaluator neural network. For convenience, the process 300 will be described as being performed by a system of one or more computers located in one or more locations. For example, a neural architecture search system, e.g., the neural architecture search system 100 of FIG. 1, appropriately programmed, can perform the process 300.

The system receives a set of K sample machine learning tasks (step 302). Each task in the set of K sample machine learning tasks is associated with a respective sample training dataset. The set of K sample machine learning tasks with corresponding sample training datasets can be denoted as:

Dₖ={(xᵢ^{(k)},yᵢ^{(k)})}ᵢ₌₀^{N}^{_{k−1}},k=0, . . . ,K−1,

where Nₖ is the number of data samples in the k-th task. (xᵢ^{k},yᵢ^{k}) is the i-th sample and its corresponding label in the k-th sample training dataset.

For each of the plurality of sample machine learning tasks, the system generates a respective sample meta-features tensor for the sample training dataset associated with the sample machine learning task (step 304).

For each of the plurality of sample machine learning tasks, the system repeatedly performs step 306-310 as follows.

The system samples, from the search space, at least one sample architecture (step 306).

The system receives a sample performance score of the at least one sample architecture on the sample machine learning task after the at least one sample architecture has been fully trained on the sample training dataset associated with the sample machine learning task (step 308).

For example, the sample performance score can be an accuracy score representing an accuracy of the sample architecture on the sample machine learning task. In particular, the system can train an instance of neural network having the sample architecture on the sample machine learning task to determine values of parameters of the instance of neural network having the sample architecture. The system can then determine an accuracy score of the trained instance of neural network based on the performance of the trained instance of neural network on the sample machine learning task. For example, the accuracy score can represent an accuracy of the trained instance on a validation set as measured by an appropriate accuracy measure. For instance, the accuracy score can be a perplexity measure when outputs are sequences or a classification error rate when the sample machine learning task is a classification task. As another example, the accuracy score can be an average or a maximum of the accuracies of the instance for each of the last two, five, or ten epochs of the training of the instance.

The system adds an evaluator training example to an evaluator training dataset (step 310). The evaluator training example includes (i) the sample meta-features tensor associated with the sample training dataset, (ii) data specifying the at least one sample architecture, and (iii) the generated sample performance score.

The evaluator training dataset can be represented as a set of M triplets of the form:

T={(zᵢ,uᵢ,vᵢ*)}ᵢ₌₀^{M-1},

where the value vᵢ* is a sample performance score obtained when training with a sample architecture uᵢ on a sample training dataset having sample meta-features tensor zᵢ.

The system then trains the evaluator neural network using the evaluator training dataset such that the evaluator neural network is configured to process a given input including a given meta-features tensor of a given training dataset and data specifying a given input candidate architecture to generate a performance score that estimates a performance of the input candidate architecture on a given machine learning task associated with the given training dataset (step 312). For example, to train the evaluator neural network, the system can adjust values of parameters of the evaluator neural network to optimize in objective function. The objective function can be, for example, a squared error between (i) predicted performance scores that the evaluator neural network generates for given input architectures and input meta-features tensors in the evaluator training dataset and (ii) sample performance scores associated with these input architectures and input meta-features tensors in the evaluator training dataset.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of determining a final architecture for a task neural network for performing a target machine learning task, wherein the target machine learning task is associated with a target training dataset, the method comprising:
generating a target meta-features tensor for the target training dataset, wherein the target meta-features tensor represents features of the target training dataset;
repeatedly performing the following operations:
generating, from a search space defining a plurality of architectures, a candidate architecture for the task neural network for performing the target machine learning task; and
processing an input comprising the target meta-features tensor and data specifying the candidate architecture using an evaluator neural network to generate a candidate performance score that estimates a performance of the candidate architecture on the target machine learning task; and
identifying, as the final architecture, a candidate architecture that has a maximum candidate performance score among the candidate architectures.

2. The method of claim 1, wherein the search space is represented by a plurality of continuous architecture parameters.

3. The method of claim 2, wherein generating, from the search space, the candidate architecture for the task neural network comprises:
generating new values for the set of architecture parameters from current values of the plurality of architecture parameters; and
generating the candidate architecture based on the new values of the set of architecture parameters.

4. The method of claim 3, wherein generating the new values for the set of architecture parameters from the current values of the set of architecture parameters comprises:
performing a gradient ascent search from the current values of the set of architecture parameters in the search space, comprising determining a gradient of an output of the evaluator neural network with respect to the current values of the set of architecture parameters while holding parameters of the evaluator neural network fixed; and
returning a result of the gradient ascent search as the new values of the set of architecture parameters.

5. The method of claim 3, wherein generating the new values for the set of architecture parameters from the current values of the set of architecture parameters comprises:
performing a random search from the current values of the set of architecture parameters in the search space;
returning a result of the random search as the new values of the set of architecture parameters.

6. The method of claim 2, wherein the task neural network comprises a plurality of parametrized layers with each parametrized layer being a weighted combination of one or more baseline layers based on parametrization weights, and wherein the parameterization weights for each parametrized layer are in the set of continuous architecture parameters.

7. The method of claim 6, wherein the parametrized layers in the task neural network are further combined according to activation weights, and wherein the activation weight for each parametrized layer belongs to the set of continuous architecture parameters and is a weight by which the output of the parametrized layer is multiplied before being provided to another layer of the task neural network.

8. The method of claim 6, wherein the first parametrized layer of the neural network is a parametrized embedding layer that is a weighted combination of one or more baseline embedding layers based on embedding weights, wherein the embedding weights belong to the set of continuous architecture parameters.

9. The method of claim 8, wherein the parametrization weights, action weights, and embedding weights define the continuous search space for candidate architectures.

10. The method of claim 1, further comprising training the evaluator neural network, wherein training the evaluator neural network comprises:
receiving a plurality of sample machine learning tasks, wherein each of the plurality of sample machine learning tasks is associated with a sample training dataset;
generating, for each of the plurality of sample machine learning tasks, a respective sample meta-features tensor for the sample training dataset associated with the sample machine learning task;
for each of the plurality of sample machine learning tasks, repeatedly performing the following operations:
sampling, from the search space, at least one sample architecture;
receiving a sample performance score of the at least one sample architecture on the sample machine learning task after the at least one sample architecture has been fully trained on the sample training dataset associated with the sample machine learning task;
adding an evaluator training example to an evaluator training dataset, wherein the evaluator training example comprises (i) the sample training dataset associated with the sample machine learning task, (ii) the sample meta-features tensor associated with the sample training dataset, (iii) data specifying the at least one sample architecture, and (iv) the generated sample performance score; and
training the evaluator neural network using the evaluator training dataset such that the evaluator neural network is configured to process a given input comprising a given meta-features tensor of a given training dataset and data specifying a given input candidate architecture to generate a performance score that estimates a performance of the input candidate architecture on a given machine learning task associated with the given training dataset.

11. The method of claim 10, wherein generating the target meta-features tensor for the target training dataset comprises:
processing, using a feature generator neural network, the particular training dataset to generate the target meta-features tensor,
wherein the feature generator neural network has been trained to process a given training dataset to generate a corresponding meta-features tensor for the given training dataset.

12. The method of claim 11, wherein the evaluator neural network and the feature generator neural network are jointly trained using a common objective function.

13. The method of claim 12, wherein the common objective function minimizes the difference between (i) sample performance scores received for the plurality of sample machine learning tasks, and (ii) performance scores predicted by the evaluator neural network given the plurality of sample machine learning tasks.

14. The method of claim 1, comprising:
outputting data defining the final architecture to a remote computing system; and/or
training an instance of a neural network having the final architecture, using the trained neural network having the final architecture to process received inputs, and providing outputs generated by the trained neural network or data derived from the generated outputs.

15. The method of claim 1, wherein the target machine learning task is an image processing task and the target training dataset includes images.

16. A system comprising one or more computers and one or more storage devices storing instructions that, when executed by the one or more computers, cause the one or more computers to perform operations comprising:
generating a target meta-features tensor for the target training dataset, wherein the target meta-features tensor represents features of the target training dataset;
repeatedly performing the following operations:
generating, from a search space defining a plurality of architectures, a candidate architecture for the task neural network for performing the target machine learning task; and
processing an input comprising the target meta-features tensor and data specifying the candidate architecture using an evaluator neural network to generate a candidate performance score that estimates a performance of the candidate architecture on the target machine learning task; and
identifying, as the final architecture, a candidate architecture that has a maximum candidate performance score among the candidate architectures.

17. One or more computer storage media storing instructions that, when executed by one or more computers, cause the one or more computers perform operations comprising:
generating a target meta-features tensor for the target training dataset, wherein the target meta-features tensor represents features of the target training dataset;
repeatedly performing the following operations:
generating, from a search space defining a plurality of architectures, a candidate architecture for the task neural network for performing the target machine learning task; and
processing an input comprising the target meta-features tensor and data specifying the candidate architecture using an evaluator neural network to generate a candidate performance score that estimates a performance of the candidate architecture on the target machine learning task; and
identifying, as the final architecture, a candidate architecture that has a maximum candidate performance score among the candidate architectures.

18. The system of claim 16, wherein the search space is represented by a plurality of continuous architecture parameters.

19. The system of claim 18, wherein the operations for generating, from the search space, the candidate architecture for the task neural network comprise:
generating new values for the set of architecture parameters from current values of the plurality of architecture parameters; and
generating the candidate architecture based on the new values of the set of architecture parameters.

20. The system of claim 19, wherein the operations for generating the new values for the set of architecture parameters from the current values of the set of architecture parameters comprise:
performing a gradient ascent search from the current values of the set of architecture parameters in the search space, comprising determining a gradient of an output of the evaluator neural network with respect to the current values of the set of architecture parameters while holding parameters of the evaluator neural network fixed; and
returning a result of the gradient ascent search as the new values of the set of architecture parameters.
